(19) United States
(12) Patent Application Publication
(10) Pub. No.: US 2013/0205626 A1
(43) Pub. Date: Aug. 15, 2013

(54) LED LIGHTING DEVICE WITH BACKUP SWITCHING FUNCTION

(71) Applicant: Lieh-Hsiung Hu, Taichung City (TW)

(72) Inventor: Lieh-Hsiung Hu, Taichung City (TW)

(73) Assignee: SAFETY TRAFFIC EQUIPMENT CO., LTD, Taichung City (TW)

(21) Appl. No.: 13/397,116

(22) Filed: Feb. 15, 2012

(51) Int. Cl. G09F 13/00; H05B 37/02

(52) U.S. Cl. 40/541; 315/93

(57) ABSTRACT

An LED lighting device with backup switching function has a device main body, configured with at least one LED fitting part and one power supply part. At least one LED component is configured on the LED fitting part and has a main lighting circuit. A backup lighting circuit is fitted inside the same LED component as the main lighting circuit or inside a different LED component. A backup switching processor is electrically connected to and fitted between the main lighting circuit and backup lighting circuit and is connected to the power supply. Based on the automatic detection function of the backup switching processor, in case of short circuit or broken circuit of the main lighting circuit, the switching processor will automatically switch to the backup lighting circuit and maintain continuous lighting of the LED component, and consequently increase the lifecycle of the LED component and reduce repair frequency and cost.

### CROSS-REFERENCE TO RELATED U.S. APPLICATIONS Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates to an LED lighting device, and particularly to an innovative one with a backup switching function.

2. Description of Related Art Including Information Disclosed Under 37 CFR 1.97 and 37 CFR 1.98

All electronic products may have failure during usage and it is also the case with LED lighting components or devices. At present, LED is widely used in numerous products like out-door advertisement plates, traffic signs, lighting devices, etc. If one or part of the LED unit has failure and cannot light, the display information represented by this LED unit (text, arrow, warning message, etc.) will disappear, causing difficulty or error in recognition and judgment.

However, the repair or replacement of the LED units on most of the currently used lighting devices cannot be completed immediately due to complicated and massive structure of the electric connection or the form of installation and fitting of the base plate. To repair or replace the failing part, the technicians must carry out proper and accurate sectional operation on the circuit, and remove the related base plate. For instance, one single large-scale traffic sign plate may be fitted with hundreds of LED components, and among them, each group of LED components may form a unit circuit system through the base plate, and various unit circuit systems are electrically connected to each other and integrated and managed by a controller. Therefore, in case of failure of any one of the LED components, all the LED components inside this unit circuit system cannot light. Under such a circumstance, if the repair cannot be completed in a short time, the warning and indicating functions of the traffic sign is seriously affected.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The LED lighting device with backup switching function disclosed in the present invention features an LED component configured on the device main body and having a main lighting circuit, a backup lighting circuit fitted inside the same LED component as the main lighting circuit or inside a different LED component, and a backup switching processor electrically connected between the main lighting circuit and the backup lighting circuit. Based on such configurations, in case of short circuit or broken circuit of the main lighting circuit, the switching processor will automatically detect and switch to the backup lighting circuit to maintain continuous lighting. Compared to the prior art, such a unique and innovative design can overcome the problem of conventional lighting devices that all LED components within one unit circuit system cannot light due to failure or broken circuit of one LED component. As the present invention can maintain continuous lighting based on the automatic detecting and switching to the backup lighting circuit through the backup switching processor, it is important for the warning and indicating functions of traffic signs. It can effectively reduce repair frequency, and alleviate safety concerns of pedestrians and drivers due to failure of the warning traffic signs. With increased lifecycle of the LED lighting components and reduced repair frequency and cost, the practical advancement and economic benefit for industrialization of the present invention is obvious.

On the other hand, the structural design of the LED lighting device with backup switching function can maintain continuous illumination and brightness of the lamps and therefore increase their quality and lifecycle.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of the LED lighting device of the present invention fitted with an LED component.

FIG. 2 is a perspective schematic view of an embodiment of the present invention with the backup switching processor fitted inside the LED component.

FIG. 3 is a circuit view of an embodiment of the present invention with the backup switching processor fitted inside the LED component.

FIG. 4 is a sectional view of an embodiment of the present invention with the backup switching processor fitted outside the LED component.

FIG. 5 is a circuit view of an embodiment of the present invention with the backup switching processor fitted outside the LED component.

FIG. 6 is a schematic view of an embodiment of the present invention with the backup switching processor fitted outside the LED component, and controlling multiple LED components.

FIG. 7 is a partially enlarged view of an embodiment of the present invention with the main lighting circuit and backup lighting circuit fitted on different LED components.

FIG. 8 is a circuit view of an embodiment of the present invention with the main lighting circuit and backup lighting circuit fitted on different LED components or differently colored LED components.

FIG. 9 is a perspective view of the present invention with the LED lighting device in the form of an LED traffic sign.

### DETAILED DESCRIPTION OF THE INVENTION

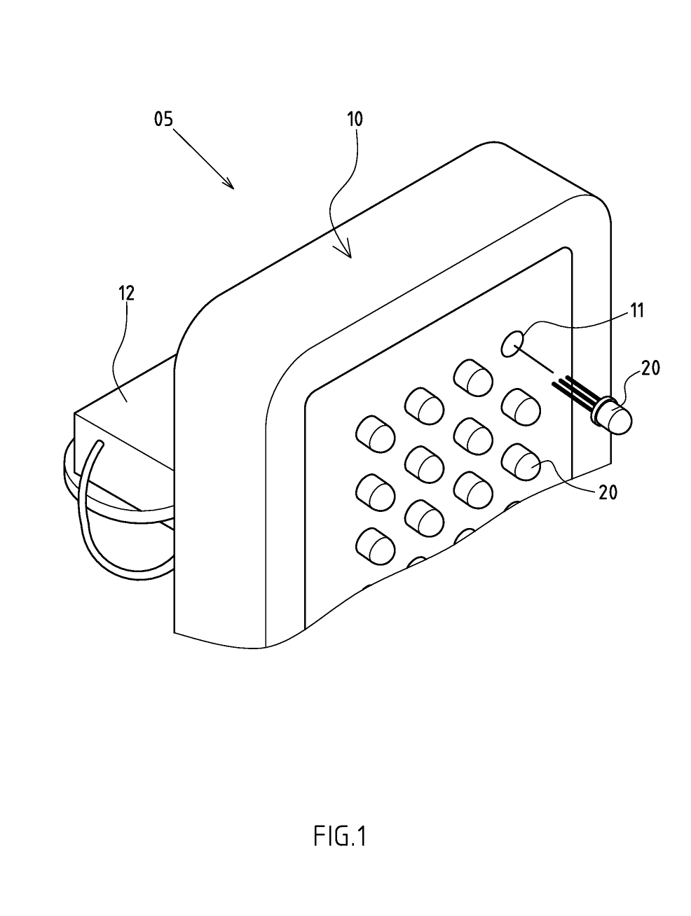

FIGS. 1 to 4 depict a preferred embodiment of the present invention of an LED lighting device with backup switching function. However, such an embodiment is illustrative only and is not intended to limit the scope of patent application.

The LED lighting device with backup switching function 05 comprises a device main body 10 which is configured with at least one LED fitting part 11 and one power supply part 12 (such as cells or power source), wherein the LED lighting device 05 can be, but not limited to, an LED advertisement plate or an LED lighting device (such as lighting bulb, lighting tube, lighting board, lighting unit etc).

At least one LED component 20 is fitted on the LED fitting part 11 of the device main body 10. Said LED component 20 has a main lighting circuit 21 (such as a semi-conductor with positive and negative electrodes), and the LED component 20 can be lighted in one single color or multiple colors.

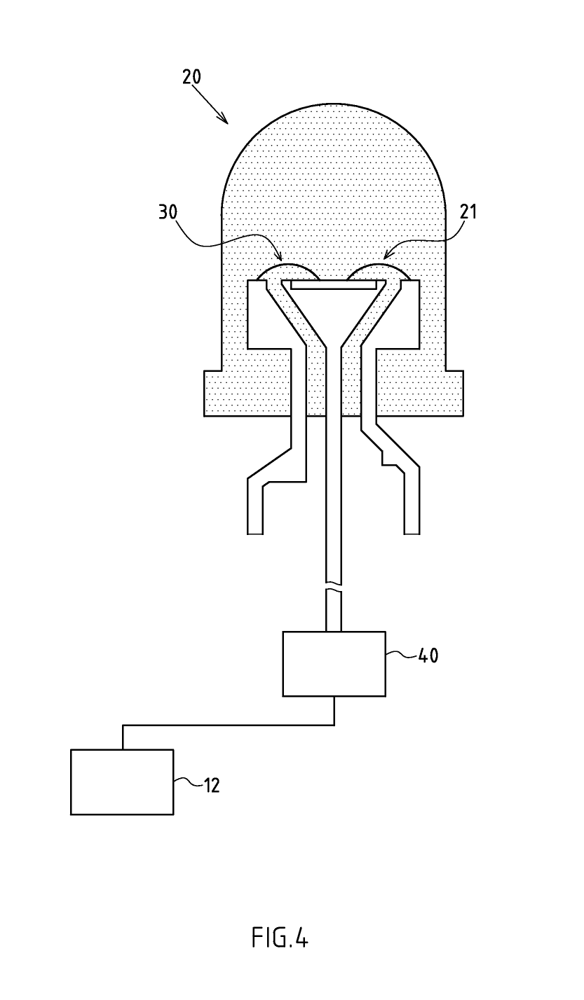

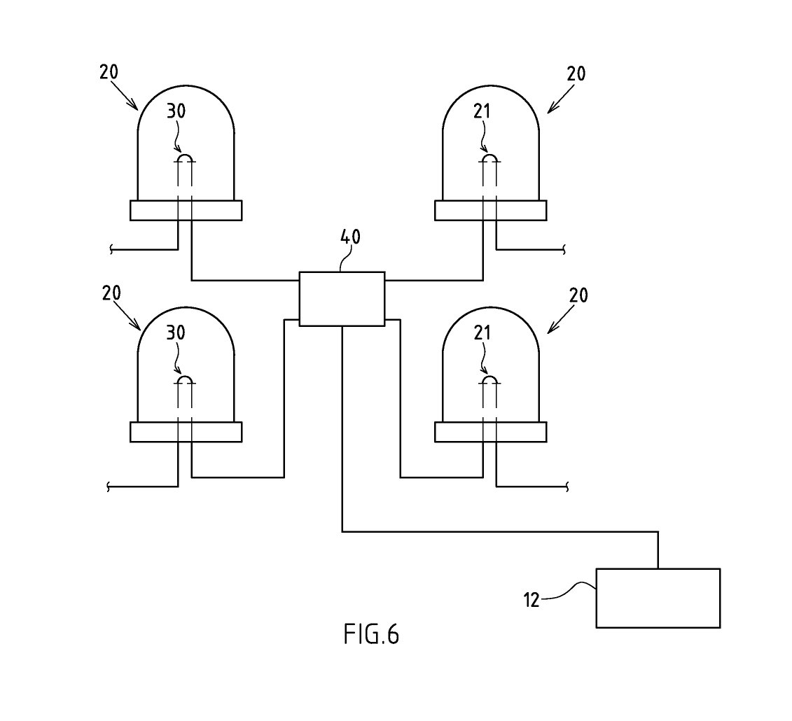

One backup lighting circuit 30 can be fitted inside the same LED component 20 as the main lighting circuit 21 or inside a different LED component 20. FIG. 4 shows an embodiment with the backup lighting circuit 30 and main lighting circuit 21 fitted inside the same LED component 20. FIGS. 6 to 8 show an embodiment with the backup lighting circuit 30 and main lighting circuit 21 fitted inside different LED components 20.

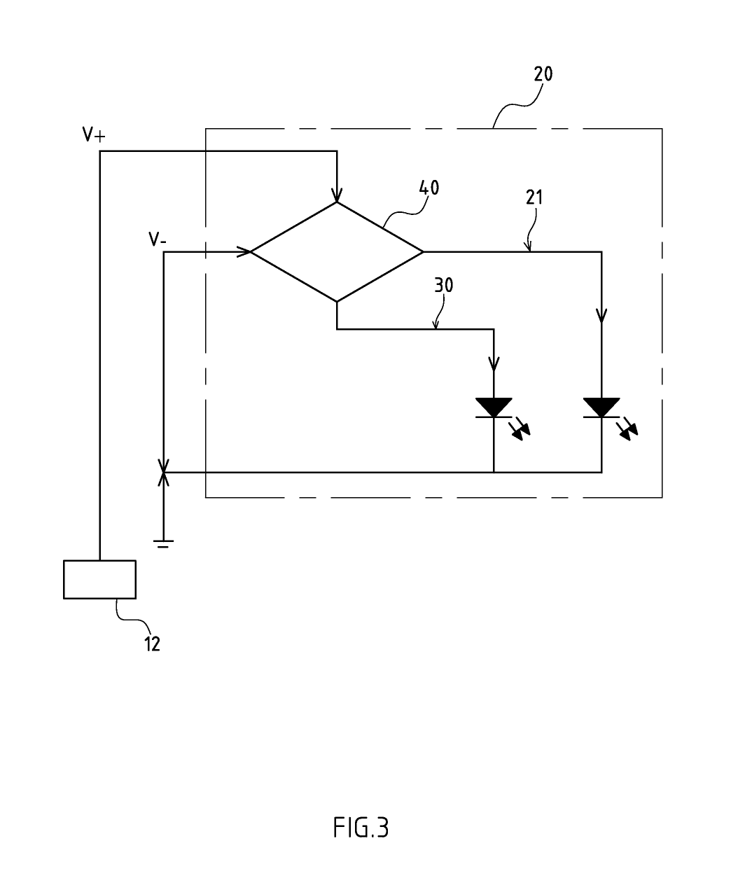

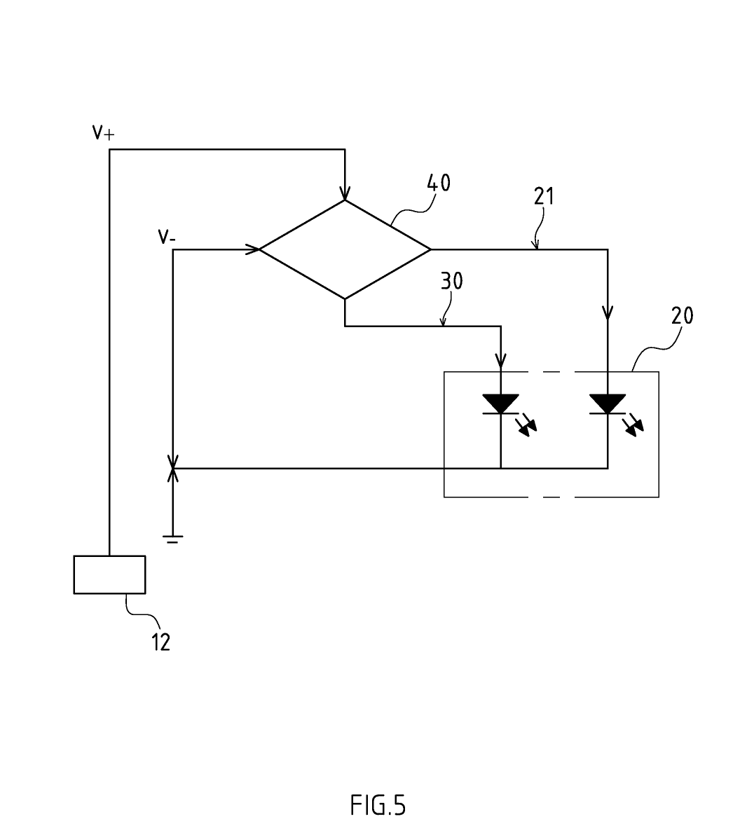

One backup switching processor 40 is electrically connected to and fitted between the main lighting circuit 21 and backup lighting circuit 30, and electrically connected to the power supply part 12. The backup switching processor 40 can be fitted inside or outside the LED component 20, as shown in FIGS. 3 and 4, if the backup switching processor 40 is fitted inside the LED component 20, the backup lighting circuit 30 and main lighting circuit 21 are both fitted inside the same LED component 20 (in this case, the backup switching processor 40 is in the form of single unit control), the backup switching processor 40 can switch the circuit to the backup lighting circuit 30 in case of short circuit or failure of the main lighting circuit 21 (open circuit and power disconnected—open), so that the lighting status of the LED component 20 can be continuous (closed circuit and power connected—close). FIGS. 4 and 5 depict an embodiment with the backup switching processor 40 fitted outside the LED component 20. In this case, the backup lighting circuit 30 and main lighting circuit 21 can be fitted inside the same LED component 20, or as shown in FIG. 6, fitted inside different LED components 20 (in this case, the backup switching processor 40 is in the form of multiple unit control). Likewise, in case of short circuit or failure of the LED component 20 of the main lighting circuit 21, the circuit can be switched to the LED component 20 of the backup lighting circuit 30 to maintain the lighting status.

Based on the above structural design, the present invention operates as follows:

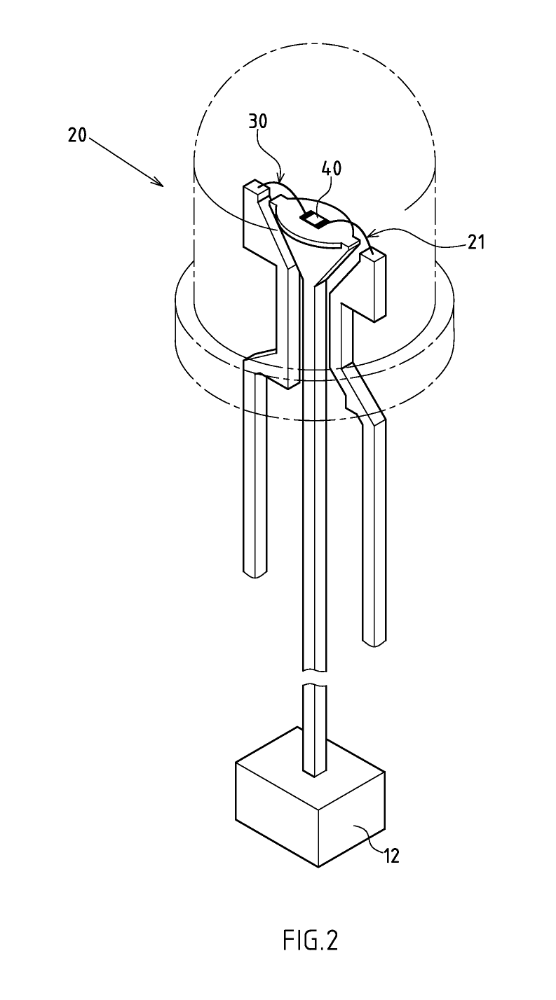

Referring to FIGS. 2 to 5, when the power supplied by the power supply part 12 of the LED lighting device 05 passes the backup switching processor 40, the main lighting circuit 21 and the backup lighting circuit 30, so that the LED component 20 is electrically connected and in a lighted status, i.e., the power supply part 12 through the backup switching processor 40 is acting as the positive input terminal, while the main lighting circuit 21 and backup lighting circuit 30 are both acting as the negative input terminal. In case of short circuit or broken circuit of the main lighting circuit 21 of the LED component 20, the backup switching processor 40 will automatically switch to the backup lighting circuit 30 and maintain continuous lighting, so as to enhance the lifecycle of the LED component 20.

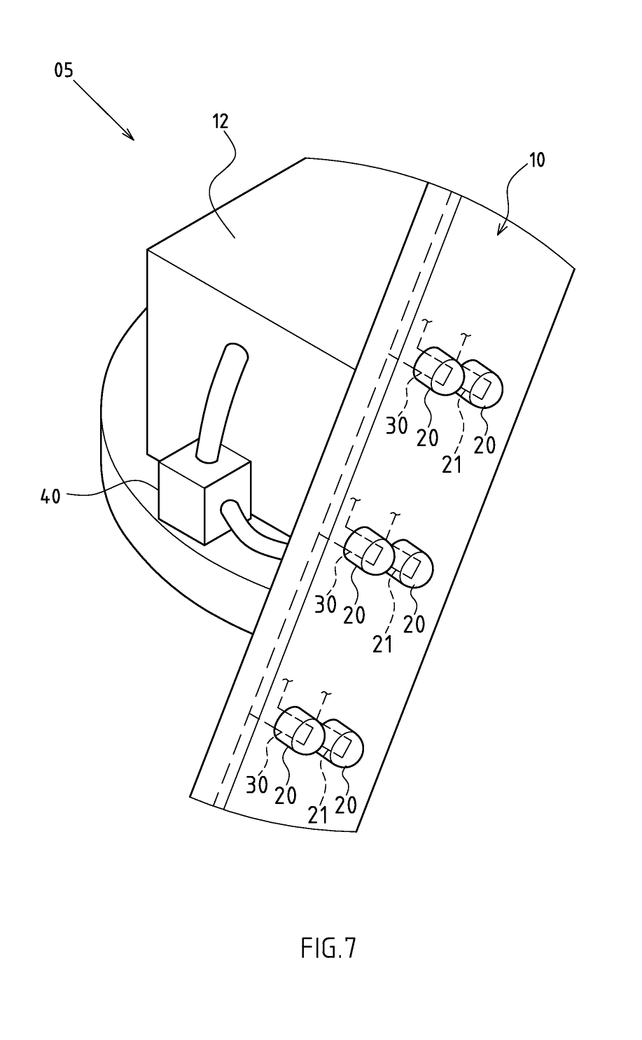

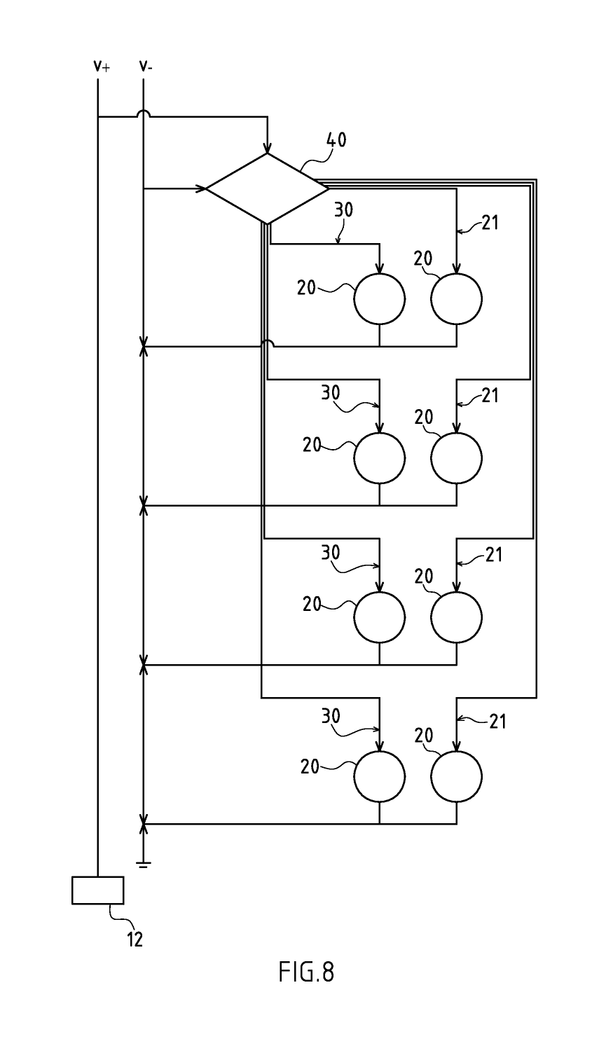

FIGS. 7 and 8 depict an embodiment in which the backup switching processor 40 is fitted outside the LED component 20, and the main lighting circuit 21 and backup lighting circuit 30 is fitted with multiple different LED components 20. Based on the power supply part 12 through the backup switching processor 40 being the positive input terminal and controlling multiple LED component 20, in case of short circuit or broken circuit of the LED component 20 of the main lighting circuit 21, the circuit can be switched to the LED component 20 of the backup lighting circuit 30, so as to maintain the lighted status, and the LED component 20 can be configured in forms of multiple colors (such as red, green, blue, yellow, white or any mixed colors). In this way, the backup switching processor 40 can simultaneously control and switch between the main lighting circuit 21 and backup lighting circuit 30 of different LED components 20 of the same lighting color system, to achieve multiple colored lighting with consistent color.

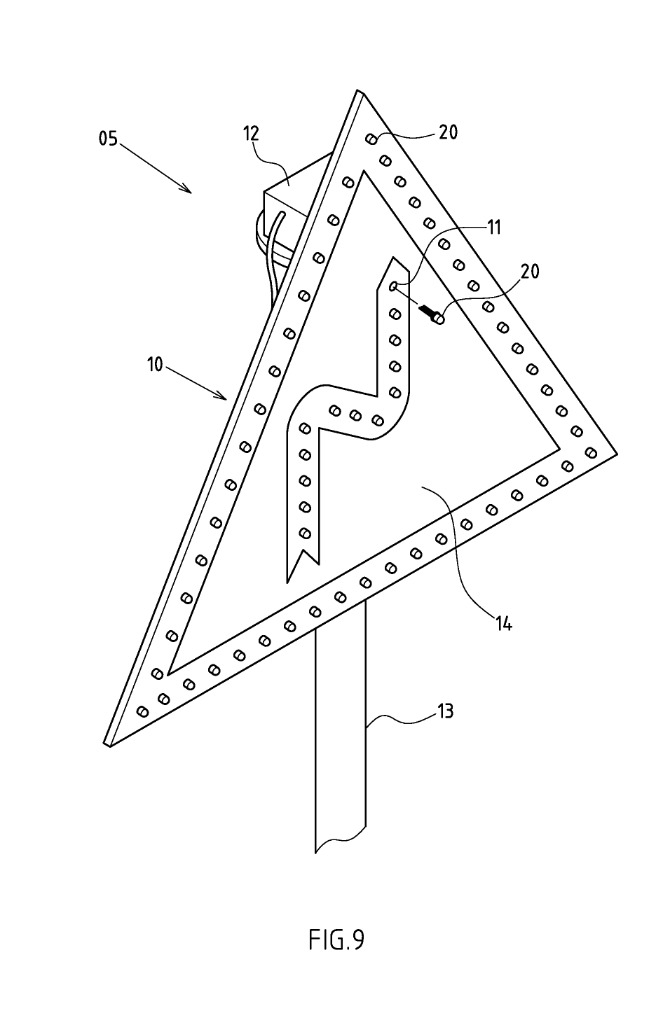

FIG. 9 depicts another embodiment of the present invention of a lighting device. This LED lighting device 05 is an LED traffic sign, and the device main body 10 comprises a support frame 13 and at least one marking surface 14, and the LED fitting part 11 is configured on the marking surface 14, so that the marking surface 14 can be lighted, and the pedestrians and drivers can clearly recognize the content indicated on the marking surface 14. The clearly recognizable warning message will help to reduce risk of accidents.

1. An LED lighting device with backup switching function, comprising:
one device main body, configured with at least one LED fitting part and one power supply part;
at least one LED component, configured on the LED fitting part of the device main body, and having a main lighting circuit;
one backup lighting circuit, fitted inside the same LED component as the main lighting circuit or inside a different LED component;
one backup switching processor, electrically connected between the main lighting circuit and the backup lighting circuit and electrically connected to the power supply part; the backup switching processor is used to automatically detect and switch to the backup lighting circuit in case of short circuit or broken circuit of the main lighting circuit, so as to maintain continuous lighting of the LED component.

2. The device defined in claim 1, wherein the backup switching processor is fitted inside the LED component; under such an embodiment, the backup lighting circuit and main lighting circuit are fitted inside the same LED component, and the backup switching processor is used to switch to the backup lighting circuit in case of short circuit or broken circuit of the main lighting circuit.

3. The device defined in claim 1, wherein the backup switching processor is fitted outside the LED component; under such an embodiment, the backup lighting circuit is fitted inside the same LED component as the main lighting circuit or inside a different LED component, and the backup switching processor is used to switch to the backup lighting circuit in case of short circuit or broken circuit of the main lighting circuit; also, the backup switching processor can be in the form of single control or multiple controls.

4. The device defined in claim 1, wherein the LED component is lighted in single color or multiple colors.

5. The device defined in claim 1, wherein the LED lighting device is in the form of an LED traffic sign, in which the device main body with the LED component comprises a support frame and at least one sign plate, and the LED fitting part is configured on the sign plate; or, the LED lighting device is any of an LED advertisement plate or an LED lighting device.
